(19) United States
(12) Patent Application Publication
(10) Pub. No.: US 2007/0068241 A1
(43) Pub. Date: Mar. 29, 2007

(54) Volume measuring device

(76) Inventor: Narinngs Singh Bains, LEAMINGTON SPA (GB)

Correspondence Address: Narinour Bains, 41 Clapham Terrace, Leamington Spa, CV31 1HZ, GB

(21) Appl. No.: 10/579,553

(22) PCT Filed: Nov. 8, 2004
(86) PCT No.: PCT/GB04/04698

§ 371 Date: May 16, 2006

(30) Foreign Application Priority Data
Nov. 20, 2003 (GB) 0327026.1

(51) Int. Cl. G01F 17/00

(52) U.S. Cl. 73/149

(57) ABSTRACT

The volume measuring device (9) is a linear solenoid-based piston-type device designed to measure the separate gaseous (12) and non-gaseous (11) volumes of a di-phasic mixture within a vessel (10). The invention is attached to a vessel containing the materials as illustrated in FIG. 9, and effects a small change in volume of the gaseous fraction of material in the vessel. During each solenoid piston (5) stroke the invention takes a continual series of measurements. By applying a technique derived from Boyle's Law and other algorithms the invention determines the volume of the gaseous fraction of material within the vessel. The volume of the non-gaseous fraction is determined by subtracting the gaseous volume from the known volume of the vessel. Significantly, there is no requirement for knowledge of the absolute pressure or temperature.

The invention relates to a volume measuring device designed to determine the separate volumes of the gaseous and non-gaseous fractions of a di-phasic mixture contained within a vessel.

An example of the application of this invention would be to measure the volume of gas above the liquid level in some liquid-containing vessel or the volume of gas within a container that contained bulk solids or even solid particulates such as dust and powder. The volume of the non-gaseous material would then be derived from simply knowing the overall volume of the containing vessel.

Currently used apparatus for measuring liquid levels are prone to inaccuracies that arise due to the position of the vessel with respect to the horizontal and also the irregular shape of many vessels.

Currently, the measurement of the solid phase within a vessel that contains a di-phasic mixture of that solid and a gaseous fraction is also very limited with present apparatus. Measurements of the amount of bulk solid material rely upon some estimation of the original volume of the solid within the vessel and an approximate record of the material that has been removed over time. Alternatively, the vessel is weighed, the tare weight removed and the weight/volume of the solid thereby calculated. There is currently no existing technique for the measurement of the volume of a dust or particulate solid that is air-borne within a vessel (e.g coal or flour dust etc.)

The invention is an improvement upon prior art as its essential features are dependent upon Boyle's Law. The instantaneous volume of the gaseous fraction contained within a vessel under test is changed by a very small amount. As a consequence of this change in volume, the gaseous pressure within the vessel under test changes in an inversely proportional fashion.

The simple application of Boyle's Law could be used to determine the instantaneous volume of the gaseous fraction of material within the vessel under test, and by a process of subtraction, the volume of the remaining non gaseous fraction. This, however, requires the knowledge or measurement of the absolute pressure, and possibly the temperature, of the gaseous fraction both before and after the change in gaseous volume.

This new invention relies upon the relationship between the rate of change of pressure of the gaseous fraction and the associated small changes to the overall instantaneous volume of the gaseous fraction within the vessel. It is this relationship which allows for the determination of the volume of the gaseous fraction and thus the volume of the non gaseous fraction of material with the vessel. In so doing, it avoids the need for knowing the absolute pressure or temperature.

The preferred embodiment of this invention is a linear solenoid-based piston-type device, although other configurations of actuator are possible.

Referring to the drawings,

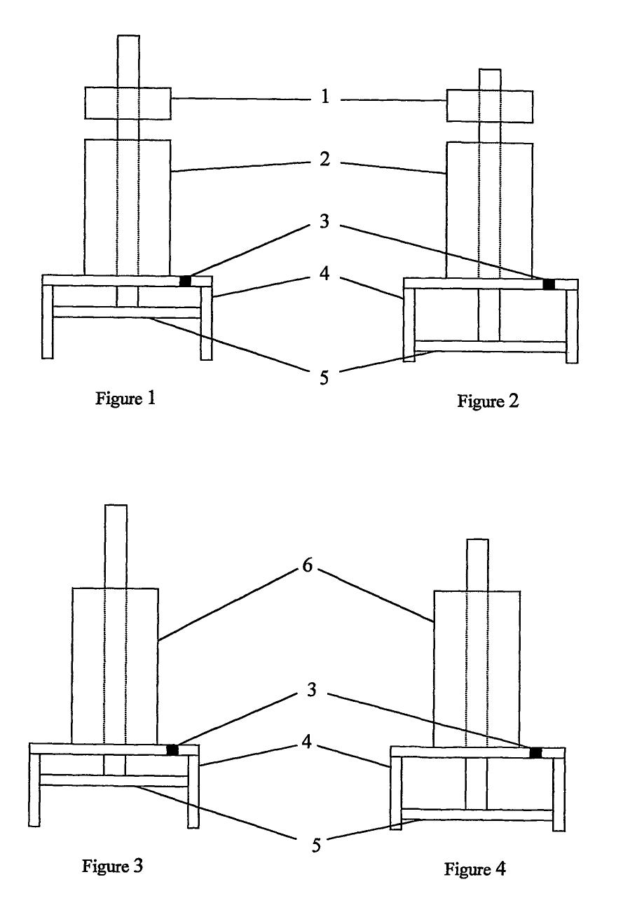

FIGS. 1, 3, 5, 7 represent four alternative but essentially identical (in terms of their basic principles of operation) manifestations of the invention. FIGS. 1, 3, 5 and 7 show the invention with the piston in a fully retracted position while

FIGS. 2, 4, 6 and 8 show the corresponding manifestation of the invention with the piston in the fully extended position.

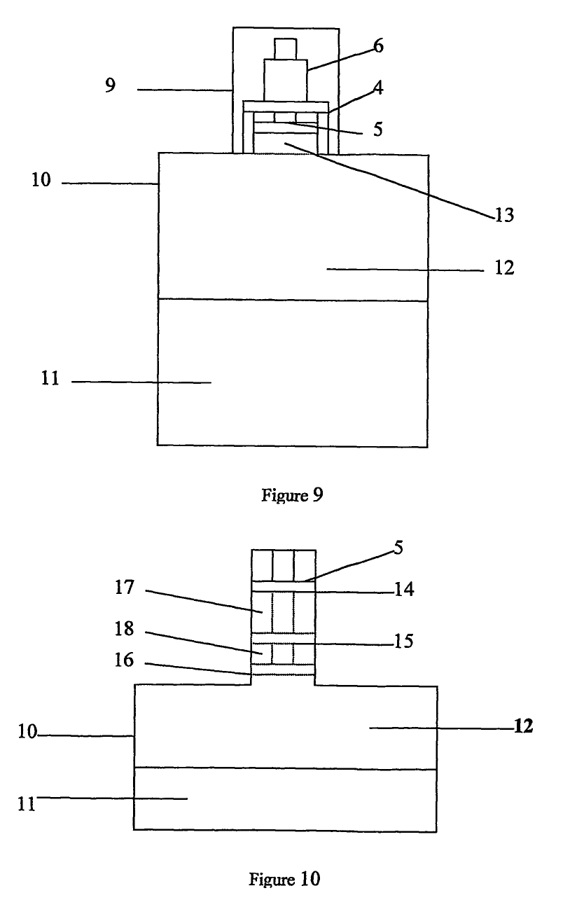

FIG. 9 illustrates the invention, ie the actuator, in relation to the vessel containing the gaseous and non-gaseous material to be measured.

FIG. 10 illustrates positions of the piston stroke where measurements are taken, albeit that measurements are actually recorded continuously.

The manifestation of the invention illustrated by FIGS. 1 and 2 show:
Labelled 1—a position sensor, which measures the relative position of the piston, in the form of a LVDT (linear variable displacement transducer). It is possible to use a different form of position sensor.
Labelled 2—a motive solenoid that drives the piston.
Labelled 3—a vent to equalise pressure to external ambient pressure and thus minimise resistance
Labelled 4—the cylinder
Labelled 5—the piston and shaft with a flush fitting piston head, the material of the shaft also forming the solenoid core.

The manifestation of the invention illustrated by FIGS. 3 and 4 show:
Labelled 3—a vent to equalise pressure to external ambient pressure
Labelled 4—the cylinder
Labelled 5—the piston and shaft with a flush fitting piston head
Labelled 6—a multi-tapped coil incorporating the motive solenoid and LVDT as either single or multiple windings. Again it is possible to use a different type of position sensor.

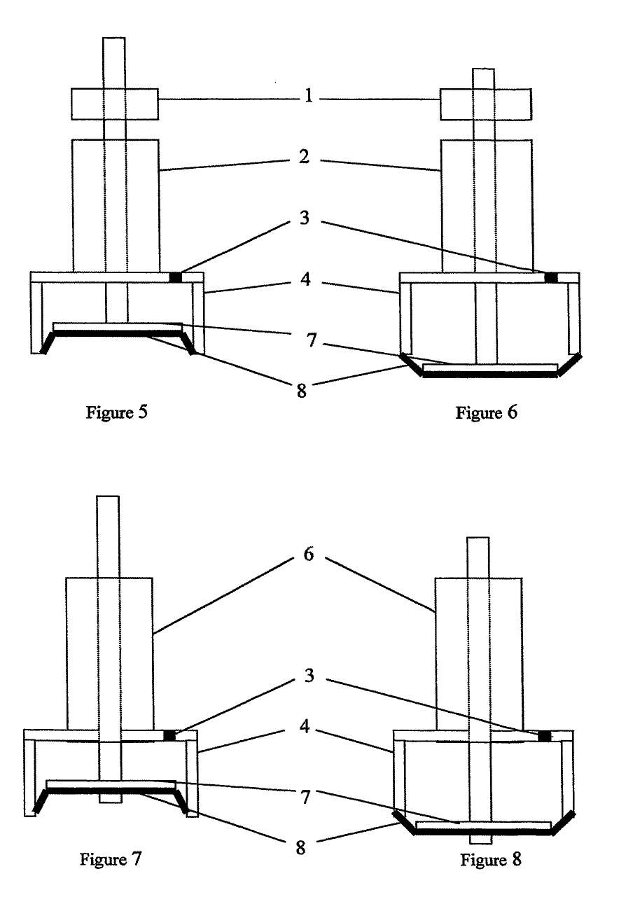

The manifestation of the invention illustrated by FIGS. 5 and 6 show:
Labelled 1—a position sensor, which measures the relative position of the piston, in this instance in the form of a LVDT
Labelled 2—a motive solenoid which drives the piston.
Labelled 3—a vent to equalise pressure to external ambient pressure
Labelled 4—the cylinder
Labelled 7—the piston and shaft with a non flush fitting piston head
Labelled 8—the flexible/elastic, air tight diaphragm operating within its normal elastic limits

The manifestation of the invention illustrated by FIGS. 7 and 8 show:
Labelled 3—a vent to equalise pressure to external ambient pressure
Labelled 4—the cylinder
Labelled 6—a multi-tapped coil incorporating the motive solenoid and LVDT as either single or multiple windings.
Labelled 7—the piston and shaft with a non flush fitting piston head
Labelled 8—the flexible/elastic, air tight diaphragm operating within its normal elastic limits

The preferred manifestation of the invention will be determined by the application environment and costs associated with the required manufacturing tolerances.

FIG. 9 shows:
Labelled 9—the invention/actuator in relation to the vessel containing the gaseous and non-gaseous fractions to be measured
Labelled 10—the vessel containing the gaseous and non-gaseous fractions to be measured
Labelled 11—the non-gaseous fraction within the vessel
Labelled 12—the initial volume of gaseous fraction within the vessel prior to any change being introduced by the invention/actuator. This includes the maximum actuator induced volume change labelled 13.
Labelled 13—the maximum invention/actuator induced volume change where this volume change is no more than 0.1% of the overall volume of the vessel labelled 10. This ensures an accuracy of at least 1% in the measurement of the volume of the gaseous fraction of the volume of the vessel.

FIG. 10 illustrates the invention introducing a change in volume of the gaseous fraction of material within the vessel.
Labelled 14—The starting position of a piston stroke.
Labelled 15—The linear displacement of the piston from position labelled 14 at some point through a compression stroke.
Labelled 17—The volume change associated with the piston moving from positions labelled 14 to 15 ie the Cross-sectional area of the cylinder (4) times by the linear displacement between positions labelled 14 to 15.
Labelled 16—The linear displacement of the piston from position labelled 14 at some point through a compression stroke.
Labelled 18—The volume change associated with the piston moving from positions labelled 15 to 16 ie the Cross-sectional area of the cylinder (4) times by the linear displacement between positions labelled 15 to 16.

There are 3 methods by which the invention achieves the required goal of determining the separate volumes of the gaseous and non gaseous fractions within a vessel. The manifestation of the invention illustrated in FIGS. 3 and 4 will be used for the rest of this description. However, any of the manifestations could be used.

The invention is attached to the test vessel containing the di-phasic as shown in FIG. 9. Either of the 3 separate method described below can then be used to determine the volume of the gaseous fraction of material within the vessel. Then, by simple subtraction of the gaseous volume from overall volume of the vessel one can determine the volume of the non-gaseous fraction of material within the vessel. This information is then displayed on some convenient external device.

Method 1:

An electric current is applied the motive solenoid (6) causing the piston to move sharply along its full stroke. This causes the volume of the gaseous fraction within the vessel to change by a very small amount, very rapidly. The high speed by which this change occurs is important so as to prevent leakage of the gaseous fraction out of the vessel thus being inconsistent with Boyle's Law.

The position sensing device (6) (in this instance an LVDT) is able to determine the exact linear displacement of the piston throughout its stroke. By knowing the cross-sectional area of the cylinder (4) and the linear displacement it is possible to determine the incremental volume changes introduced by the invention ie
v=Cross-sectional area of the cylinder×linear displacement
Applying Boyle's Law

$${P}_{0} V = P ( V - v )$$

$$where {P}_{0} - initial gaseous pressure$$

$$V - initial gaseous fraction volume$$

$$P - gaseous pressure after volume change v$$

$$v - small change in volume$$

$$so$$

$$P = \frac{{P}_{0} V}{( V - v )} = {{P}_{0} ( 1 - \frac{v}{V} )}^{- 1}$$

then the rate of change of the pressure of the gaseous fraction with incremental changes in volume v, ie the 1^{st} differential, is

$$\frac{ⅆ P}{ⅆ v} = {P}^{′} = - {{P}_{0} ( 1 - \frac{v}{V} )}^{- 2} * \frac{- 1}{V} = \frac{{P}_{0}}{V} {( 1 - \frac{v}{V} )}^{- 2} \qquad Equation ( 1 )$$

and the rate of change of the rate of change of the pressure of the gaseous fraction with incremental changes in volume v, ie the 2^{nd} differential, is:

$$\frac{{ⅆ}^{2} P}{ⅆ {v}^{2}} = {P}^{′′} = \frac{- 2 {P}_{0}}{V} {( 1 - \frac{v}{V} )}^{- 3} * \frac{- 1}{V} = \frac{2 {P}_{0}}{{V}^{2}} {( 1 - \frac{v}{V} )}^{- 3} \qquad Equation ( 2 )$$

If one now divide the Equation (2) by Equation (1) ie. 2^{nd} differential by the 1^{st} differential,

$$\frac{{P}^{′}}{{P}^{′′}} = \frac{{P}_{0}}{{V ( 1 - \frac{v}{V} )}^{2}} * \frac{{{V}^{2} ( 1 - \frac{v}{V} )}^{3}}{2 {P}_{0}}$$

it follows that

$$\frac{{P}^{′}}{{P}^{′′}} = \frac{V}{2} * ( 1 - \frac{v}{V} ) = \frac{- v}{2} + \frac{V}{2} \qquad Equation ( 3 )$$

ie. a classic y=mx+c linear relationship between the changing pressure and small, incremental changes in volume v. The volume of the gaseous material within the vessel is therefore twice the value of the intercept of a “best fit” line (resulting from linear regression analysis) with the y-axis.

The pressure of the gaseous fraction can be measured continuously during the piston stroke using a pressure sensitive transducer. Alternatively, one can substitute the pressure changes by measuring the electrical work done in driving the piston.

Now, the amount of electrical work done (W) to change the volume of the gaseous fraction of material in the vessel at a given instance can be shown to be:
W=Force×the linear displacement of the piston

The resistive force offered against this volume change by the gaseous material can be shown to be:
Force=Gaseous Pressure×Cross-sectional area of the cylinder (4)

So, at any given instance it can be shown that the work done is proportional to the instantaneous pressure of the gaseous fraction within the vessel ie.
W∝P

Hence, by substituting the rate of change of work done and the rate of change of the rate of change of work done into Equation (3), one obtains;

$$\frac{{W}^{′}}{{W}^{′′}} = \frac{V}{2} * ( 1 - \frac{v}{V} ) = \frac{- v}{2} + \frac{V}{2} \qquad Equation ( 4 )$$

The instantaneous voltage and current applied to the motive solenoid (6) and the displacement of the piston are measured continuously and integrated with respect to time, in order to determine the dynamic measure of the actual work consumed by the actuator as it proceeds through its stroke. The 1^{st} and 2^{nd} derivatives required by Equation (4) can be either supplied directly via analogue electronics (differentiators) or obtained by digital computation once the signals have been recorded via standard A/D conversion. Subsequent application of Equation (4) then allows the determination of the volume of the gaseous fraction of material within the vessel.

Method 2:

An electric current is applied the motive solenoid (6) causing the piston to move quickly and suddenly along its full stroke. The current and voltage are exactly regulated so that the work done, ie voltage×current, is kept constant. This causes the volume of the gaseous fraction within the vessel to change by a very small amount, very rapidly. The high speed by which this change occurs to important so as to prevent leakage of the gaseous fraction out of the vessel thus being inconsistent with Boyle's Law.

The position sensing device (6) (in this instance a LVDT) is able to determine the exact linear displacement of the piston throughout its stroke. By knowing the cross-sectional area of the cylinder (4) and the linear displacement it is possible to determine the small volume changes (dv) introduced by the invention ie
dv=Cross-sectional area of the cylinder (4)×linear displacement (d)

The pressure of the gaseous fraction can be measured continually during the piston stroke using a pressure sensitive transducer. Alternatively, one can substitute the pressure changes by measuring the electrical work done in driving the piston.

Now, the amount of electrical work done (W) to change the volume of the gaseous fraction of material in the vessel at a given instance can be shown to be:
W=Force×the linear displacement of the piston
ie. W=F×d

The resistive force offered against this volume change by the gaseous material can be shown to be:
Force=Pressure of the Gaseous fraction×Cross-sectional area of the cylinder (4)

Substituting with the volume change (dv), and applying Boyle's Law, ie PV=k, where k is some constant, to substitute for the pressure P, gives:

$$W = k \frac{1}{V} dv \qquad Equation ( 5 )$$

Therefore, the electrical work done (W₁) to introduce a small change in volume from V to V−v₁, where V is the initial gaseous fractional volume of the vessel, labelled 12 in FIG. 9, and v₁ is the small volume change introduced, labelled 17 in FIG. 10, can be shown to be:

$${W}_{1} = k {\int }_{v}^{V - {v}_{1}} \frac{1}{V} dv \qquad Equation ( 6 )$$

Performing this integration, gives

$${W}_{1} = k ln \vert \frac{V - {v}_{1}}{V} \vert \qquad Equation ( 7 )$$

As the piston stroke proceeds, additional electrical work (W₂) is done and the gaseous fraction of the whole system is further reduced by a small volume v₂, labelled 18 in FIG. 10, from V−v₁ to V−v₁−v₂. Then, substituting these values into the functional relationship described by Equation (5), gives:

$${W}_{2} = k ln \vert \frac{V - {v}_{1} - {v}_{2}}{V - {v}_{1}} \vert \qquad Equation ( 8 )$$

Since the work done over successive fixed intervals of time is kept constant, W₁ W₂. Therefore, equating Equation (7) to Equation (8), yields:

$$k ln \vert \frac{V - {v}_{1}}{V} \vert = k ln \vert \frac{V - {v}_{1} - {v}_{2}}{V - {v}_{1}} \vert \\ so , \\ \frac{V - {v}_{1}}{V} = \frac{V - {v}_{1} - {v}_{2}}{V - {v}_{1}} \\ and finally \\ V = \frac{{v}_{1}^{2}}{{v}_{1} - {v}_{2}} \qquad Equation ( 9 )$$

The instantaneous voltage and current applied to the motive solenoid (6) are measured simultaneously with the instantaneous value of the linear displacement of the piston in order to monitor the change in volume of the gaseous fraction resulting from a specific amount work throughout the piston stroke. By equating the linear displacement to volume changes, (ie linear displacement×cross-sectional area of the cylinder (4)) and applying Equation (9) to the data recovered either by analogue electronic or computation, we can determine the volume of the gaseous fraction of material within the vessel.

Alternatively, since the electrical work is kept constant over successive fixed intervals of time, one could simply measure the change in the linear displacement of the piston at fixed intervals. It can be shown that the general series solution to Equation (9) that relates the total volume of the system V to the continuous process of nth instantaneous volume measurement (v) of the actuator as it proceeds through it cycle can be described by Equation (10) below:

$$V = \frac{{v}_{n - 1}^{2}}{{v}_{n - 1} - {v}_{n}} + {\sum }_{n = 0}^{n - 2} {v}_{n} \qquad Equation ( 10 )$$

Method 3:

This method uses the motive solenoid (6) simply to restore the piston (5) to its most retracted position after each compression stroke. The piston is move quickly and suddenly along its compression stroke by some constant force. The source of this force could be electromagnetic, spring, pneumatic, gravity or anything else provided that it is constant throughout the compression stroke of the piston.

This changes the volume of the gaseous fraction within the vessel to change by a very small amount, very rapidly. The high speed by which this change occurs is important so as to prevent leakage of the gaseous fraction out of the vessel thus contravening Boyle's Law.

The rate of compression can be slower depending upon how efficiently the vessel is sealed against and gaseous leakage.

The position sensing device (6) (in this instance a LVDT) is able to determine the exact linear displacement of the piston throughout its stroke. By knowing the cross-sectional area of the cylinder (4) and the linear displacement it is possible to determine the small volume changes (dv) introduced by the invention ie
dv=Cross-sectional area of the cylinder (4)×linear displacement (d)

The pressure of the gaseous fraction can be measured continually during the piston stroke using a pressure sensitive transducer. Alternatively, one can substitute the pressure changes by measuring the electrical work done in driving the piston.

Now, the amount of work done (W) to change the volume of the gaseous fraction of material in the vessel at a given instance can be shown to be:
W=Force×the linear displacement of the piston
ie. W=F×d

The resistive force offered against this volume change by the gaseous material can be shown to be:
Force=Pressure of the Gaseous fraction×Cross-sectional area of the cylinder (4)

Substituting with the volume change (dv), and applying Boyle's Law, ie PV=k, where k is some constant, to substitute for the pressure P, gives:

$$W = k \frac{1}{V} ⅆ v as in Method 2 \qquad Equation ( 5 )$$

Therefore, the work done (W₁) to introduce a small change in volume from V to V−v₁ where, V is the initial gaseous fractional volume of the vessel, labelled 12 in FIG. 9, and v₁ is the small volume change introduced, labelled 17 in FIG. 10, can be shown to be:

$${W}_{1} = k {\int }_{V}^{V - {v}_{1}} \frac{1}{V} ⅆ v as in method 2 \qquad Equation ( 6 )$$

Performing the integration, we gives:

$${W}_{1} = k ln \vert \frac{V - {v}_{1}}{V} \vert as in method 2 \qquad Equation ( 7 )$$

As the piston stroke continues, and more work (W₂) is done, the gaseous fraction is further reduced by a small volume v₂, labelled 18 in FIG. 10, from V−v₁ to V−v₁−v₂. Then, substituting into Equation (5), gives:

$${W}_{2} = k ln \vert \frac{V - {v}_{1} - {v}_{2}}{V - {v}_{1}} \vert as in method 2 \qquad Equation ( 8 )$$

Since the work done over successive fixed intervals of time is kept constant, W₁=W₂. Therefore, equating Equation (7) to Equation (8), yields:

$$k ln \vert \frac{V - {v}_{1}}{V} \vert = k ln \vert \frac{V - {v}_{1} - {v}_{2}}{V - {v}_{1}} \vert \\ so , \\ \frac{V - {v}_{1}}{V} = \frac{V - {v}_{1} - {v}_{2}}{V - {v}_{1}} \\ and finally \\ V = \frac{{v}_{1}^{2}}{{v}_{1} - {v}_{2}} as in method 2 \qquad Equation ( 9 )$$

Since the work done in compressing the gaseous fraction is constant, then the work done in any unit period of time is also constant. The instantaneous value of the linear displacement of the piston is measured in order to monitor the change in volume of the gaseous fraction for a specific amount of time throughout the piston stroke. By equating the linear displacement to volume changes, (ie linear displacement×cross-sectional area of the cylinder (4)) and applying Equation (9) to the data recovered either by analogue electronic or computation, we can determine the volume of the gaseous fraction of material within the vessel.

Alternatively, since the work is kept constant over successive fixed intervals of time, one could simply measure the change in the linear displacement of the piston at fixed intervals. It can be shown that the general series solution to Equation (9) that relates the total volume of the system V to the continuous process of nth instantaneous volume measurement (v) of the actuator as it proceeds through it cycle can be described by Equation (10) below:

$$V = \frac{{v}_{n - 1}^{2}}{{v}_{n - 1} - {v}_{n}} + {\sum }_{n = 0}^{n - 2} {v}_{n} as in method 2 \qquad Equation ( 10 )$$

1. A volume measuring device for measuring a volume of gas within a vessel, the device being arranged to:
produce a continuous change in the volume of the gas;
measure the rate of change of pressure of the gas with respect to the volume by determining incremental changes if volume throughout the change in volume, and measuring incremental pressure changes associated with respective volume changes, or work done during respective volume changes;
use the measurements to determine a straight line relationship;
and determine the volume of the gas from the volume changes and either the pressure changes or work done.

2. A device according to claim 1 including a piston arranged to produce the change in volume of the gas in a single stroke.

3. A device according to claim 1 or claim 2 including a pressure sensor arranged to measure the incremental pressure changes.

4. A device according to claim 3 arranged to estimate a best fit straight line relationship from the measurements.

5. A device according to claim 3 or claim 4 wherein the straight line relationship includes first and second derivatives.

6. A device according to any claims 3 to 5 arranged to determine the volume from an intercept of the straight line relationship.

7. A device according to any foregoing claim including a piston arranged to produce the continuous change in volume.

8. A method of measuring a volume of gas within a vessel, the method comprising:
producing a continuous change in the volume of the gas;
measuring the rate of change of pressure of the gas with respect to the volume by determining incremental changes if volume throughout the change in volume, and measuring incremental pressure changes associated with respective volume changes, or work done during respective volume changes;
using the measurements to determine a straight line relationship;
and determining the volume of the gas from the volume changes and either the pressure changes or work done.

9. A method according to claim 8 wherein the gas is part of a di-phasic mixture.
